(19) United States
(12) Patent Application Publication
(10) Pub. No.: US 2004/0100500 A1
(43) Pub. Date: May 27, 2004

(54) Method of focusing on input item in object picture embedded in markup picture, and information storage medium therefor

(75) Inventors: Hyun-Kwon Chung, Seoul (KR); Jung-Kwon Heo, Seoul (KR); Sung-Wook Park, Seoul (KR); Kil-Soo Jung, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/693,967

(22) Filed: Oct. 28, 2003

(30) Foreign Application Priority Data
Nov. 22, 2002 (KR) 2002-73118

(51) Int. Cl. G09G 5/00

(52) U.S. Cl. 345/767

(57) ABSTRACT

A method and apparatus to focus on input items in an object picture embedded in a markup picture. An object interpretation engine for the object picture transmits a message for moving a focus to a markup interpretation engine for the markup picture in response to a key of a user input device pressed to move the focus. The markup interpretation engine focuses on one of the input items according to a predetermined order in response to the message.

### CROSS-REFERENCE TO RELATED APPLICATIONS

This application claims the priority of Korean Patent Application No. 2002-73118, filed on Nov. 22, 2002, in the Korean Intellectual Property Office, the disclosure of which is incorporated herein in its entirety by reference.

### BACKGROUND OF THE INVENTION

1. Field of the Invention

The present invention relates to a method of navigating interactive contents, and more particularly, to a method of focusing on at least one of input items in an object picture embedded in a markup picture, and an apparatus and information storage medium therefor.

2. Description of the Related Art

In the present invention, “interactive contents” refer to bilateral contents having a user interface, which is unlike contents provided regardless of intention of a user, and the interactive contents can communicate with the user via the user interface.

Some example interactive contents are data recorded on interactive DVDs, the data being reproducible in a personal computer (PC). Audio/video (AV) data can be reproduced from the interactive DVDs in an interactive mode using a PC. The interactive DVDs contain AV data according to conventional DVD-Video standards and further contain markup documents for supporting interactive functions. Thus, AV data recorded on an interactive DVD can be displayed in two modes: a video mode in which AV data is displayed according to a normal method of displaying DVD-Video data and an interactive mode in which an AV picture formed by AV data is displayed while being embedded in a markup picture formed by a markup document. A markup picture is display of data written in a markup language (i.e., a displayed markup document). The AV picture is embedded in the markup picture. For example, in a case where AV data is a movie title, the movie is shown in an AV picture and various additional pieces of information, such as scripts and plots of the movie, photos of actors and actresses, and so forth, are displayed in the remaining portion of the markup picture. The various additional pieces of information may be displayed in synchronization with the title. For example, when a specific actor or actress appears, information on backgrounds of the actor or actress may be displayed.

A user selectable displayed element of a markup document is recorded using a tag. An operation assigned to the element is performed when the user selects the displayed element. The state in which the user selects the specific element refers to a focused state, i.e., a “focus on state”.

A conventional method of focusing on displayed elements of a markup document (i.e., focusing on markup picture elements) is carried out as follows.

1. A corresponding element can be focused using a pointing device, such as a mouse, a joystick, or the like.

2. Each of the elements of the markup document can be assigned a predetermined selection order. Thus, a focus can sequentially move from an element to another element according to the predetermined selection order using an input device, such as a keyboard or the like. A markup document maker can determine a focusing order for the elements using “Tabbing Order”. A user can sequentially focus on the elements using a “tab” key of the keyboard.

3. The elements are assigned access key values to directly focus on a corresponding element. An access key value assigned to the corresponding element is received from a user input device to focus on the corresponding element.

When an object program is linked to the markup document, an object picture formed by the object program is displayed while being embedded in a markup picture formed by (displayed according to) the markup document. However, in an event that the object picture has focusable input items, such as at least one button, links, or the like, problems occur in focusing on the object picture. For explaining a conventional markup picture focusing method, FIGS. 1, and 2A, 2B and 2C are schematic views of pictures played back and displayed from an interactive DVD in an interactive mode. Referring to FIG. 1, a displayed object picture, which is a DVD-Video picture, is embedded in a markup picture. Links, and a button, as focusable input items, are displayed in the markup picture, and input items \mathring{1}, \mathring{2}, and \mathring{3} are displayed in the object picture.

FIG. 2A is a displayed markup picture in which a link is focused. In case a DVD playback system comprising a TV/display monitor and a DVD player (for example, a typical home DVD playback system) is used to display the interactive DVD, when a user presses a “down” direction key of a remote control of the DVD playback system as an input device, a focus moves to another link as shown in FIG. 2B. When the user presses a “left” direction key, as shown in FIG. 2C, the focus moves to a left element, i.e., the DVD-Video picture or a displayed object picture. In other words, the whole DVD-picture is focused. Conventionally, a pointing device, such as a mouse pointer, has to be used to focus on input items \mathring{1}, \mathring{2}, and \mathring{3} in the DVD-Video picture, as shown in FIG. 1.

As described above, according to the conventional markup picture focusing method using a user input device, such as a keyboard, a remote control, or the like, except a mouse pointer, the input items in a displayed object picture cannot be focused in the same way as the input items in the markup picture. In other words, a focus cannot move into the input items in the object picture embedded in the markup picture without using the mouse, while the entire object picture is focused as shown in FIG. 2C. In particular, in the case a markup picture with an embedded object picture is displayed on a PC driven DVD play back system in which the PC and a display monitor are far away from each other or on the home DVD playback device using the TV/display monitor and a DVD player, a pointing device, such as the mouse, may be too distant from/not accessible by a user or a pointing device may not be available for the user to focus on the displayed embedded object picture of the displayed markup picture. In particular, configuration of some PC driven DVD play back systems and some of the home DVD playback devices do not readily allow access to or include pointing devices but only allow using a user input device (i.e., non-pointing input device), such as a remote control or the like. As a result, focusing on input items in a displayed embedded object picture of the markup picture is further problematic.

### SUMMARY OF THE INVENTION

Accordingly, the present invention provides a method of focusing on input items in an object picture embedded in a markup picture using a user input device, such as a keyboard, a remote control, or the like, without using a pointing device, such as a mouse pointer, and an apparatus and information storage medium therefor.

The present invention also provides a method of moving a focus from input items in a markup picture to input items in an object picture embedded in the markup picture without distinguishing between the items, and an apparatus and information storage medium therefor.

Additional aspects and/or advantages of the invention will be set forth in part in the description which follows and, in part, will be obvious from the description, or may be learned by practice of the invention.

The present invention may be achieved by a method of focusing on at least one of input items in an object picture embedded in a markup picture, comprising interpreting an object program for the object picture to generate input item map information necessary for focusing on the input items; and focusing on one of the input items with reference to the input item map information in response to a direction key input from a user input device other than a pointing device.

According to an aspect of the invention, the object program has an independent program structure, such as an extensible markup language (XML) document and a Java program.

According to an aspect of the invention, the interpreting comprising obtaining information on input types of the input items, information on positions of the input items, and information on identifications of the input items from the object program; and generating the input item map information based on the information on the input types, the information on the positions, and information on the input item identifications.

According to an aspect of the invention, the focusing comprises moving a focus from a currently focused input item to an object picture input item nearest to a direction indicated by a direction key of the user input device based on the information on the input types, information on the positions, and information on the input item identifications when the direction key of the user input device is pressed.

The present invention may also be achieved by a method of focusing on at least one of input items in an object picture embedded in a markup picture, comprising transmitting a message for moving an object picture input item focus from a markup interpretation engine for the markup picture to an object interpretation engine for the object picture, in response to a pressed direction key of a user input device other than a pointing device to move the focus; and focusing by the object interpretation engine on one of the markup picture input items according to a predetermined order in response to the message.

The present invention may also be achieved by a method of focusing on at least one of input items in an object picture embedded in a markup picture, comprising transmitting a message for moving an object picture input item focus from an object interpretation engine for the object picture to a markup interpretation engine for the markup picture, in response to a pressed direction key of a user input device other than a pointing device to move the focus; and focusing by the markup interpretation engine on one of the markup picture input items according to a predetermined order in response to the message.

According to an aspect of the invention, the message transmission comprises transmitting information on a position of a currently focused markup picture input item and information on a direction along which the focus moves.

According to an aspect of the invention, the focusing comprises moving the focus from a currently focused object picture input item to a next object picture input item positioned in a direction selected based on direction information in the message transmitted from the interpretation engine.

According to an aspect of the invention, the focusing comprises moving the focus from a currently focused input item to a next focused input item determined with reference to a distance and a direction angle of each object picture and markup picture input item.

The present invention may also be achieved by an information storage medium storing a markup document written in a markup language, and an object program to be displayed as an embedded object picture in a markup picture formed by the markup document, the object program having at least one input item and containing information on an input type, information on a position, and information on an identification of the at least one input item necessary for generating input item map information.

According to an aspect of the invention, the information storage medium further stores at least one of audio contents reproduced and image contents displayed by the object program while being embedded in the markup picture.

According to an aspect of the invention, the object program has an independent program structure, such as an XML document and a Java program.

The present invention may also be achieved by an information storage medium storing a markup document, an object program, and a focus change program. The markup document is written in a markup language. The object program is displayed as an object picture embedded in a markup picture formed by the markup document and has at least one or more input items. The focus change program controls transmitting a message for moving an object picture input item focus from an object interpretation engine for the object picture to a markup interpretation engine for the markup picture, in response to a pressed key of a user input device other than a pointing device to move the focus. The focus change program uses the markup interpretation engine to focus on one of the markup picture input items according to a predetermined order, in response to the message transmitted from the object interpretation engine.

According to an aspect of the invention, the message comprises information on a position of a currently focused object picture input item and information on a direction along which the focus moves.

According to an aspect of the invention, the focus change program controls moving the focus from a currently focused object picture input item to a next markup picture input item positioned in a markup picture direction selected based on the direction information in the message transmitted from the object interpretation engine.

According to an aspect of the invention, the focus change program controls moving the focus from a currently focused input item to a next focused input item determined with reference to a distance and a direction angle of each object picture and markup picture input item.

### BRIEF DESCRIPTION OF THE DRAWINGS

The above features and/or other aspects and advantages of the present invention will become more apparent by describing in detail exemplary embodiments thereof with reference to the attached drawings in which:

FIGS. 1, and 2A, 2B, and 2C are schematic views of pictures played back and displayed from an interactive DVD in an interactive mode for explaining a conventional focusing method;

FIG. 3 is a functional block diagram of an apparatus displaying/playing back interactive contents, according to an embodiment of the present invention;

FIG. 4 is a functional layer diagram of the interactive contents playback apparatus shown in FIG. 3, according to an alternative embodiment of the present invention;

FIG. 5 is a diagram of a playback system including a playback device embodying the presentation engine shown in FIGS. 3 and 4, and including a display monitor, according to an embodiment of the present invention;

FIG. 6 is a diagram of a remote control shown in FIG. 5;

FIG. 7 is a functional block diagram of the presentation engine shown in FIG. 4, according to an embodiment of the present invention;

FIG. 8 is a reference view of a display screen displaying an object picture having input items and a map of the object picture input items for focusing on the object picture input items, according to an embodiment of the present invention;

FIG. 9 is a markup picture input item map information table necessary for focusing on the input items of the markup picture as shown in FIG. 2, according to an embodiment of the present invention;

FIGS. 10A and 10B are reference views of display screens displaying a markup picture including an embedded object picture for explaining a method of focusing on the object picture input items, according to the alternative embodiment of the present invention;

FIG. 11 is a flow diagram of the method presented in FIG. 10;

FIGS. 12A, 12B and 12C are reference views of display screens displaying a markup picture including an embedded object picture for explaining moving a focus among input items in the markup picture, according to the FIG. 10A embodiment of the present invention; and

FIGS. 13A, 13B, 13C and 13D are reference views of the display screens in FIGS. 12A, 12B and 12C for explaining a moving order of the focus among the input items in the markup picture in which the object picture is embedded, according to an embodiment of the present invention.

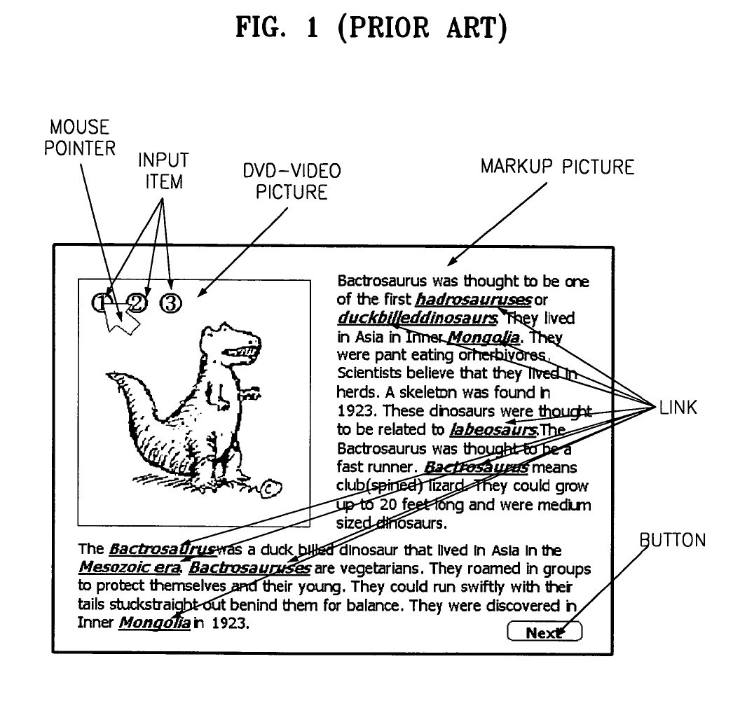

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

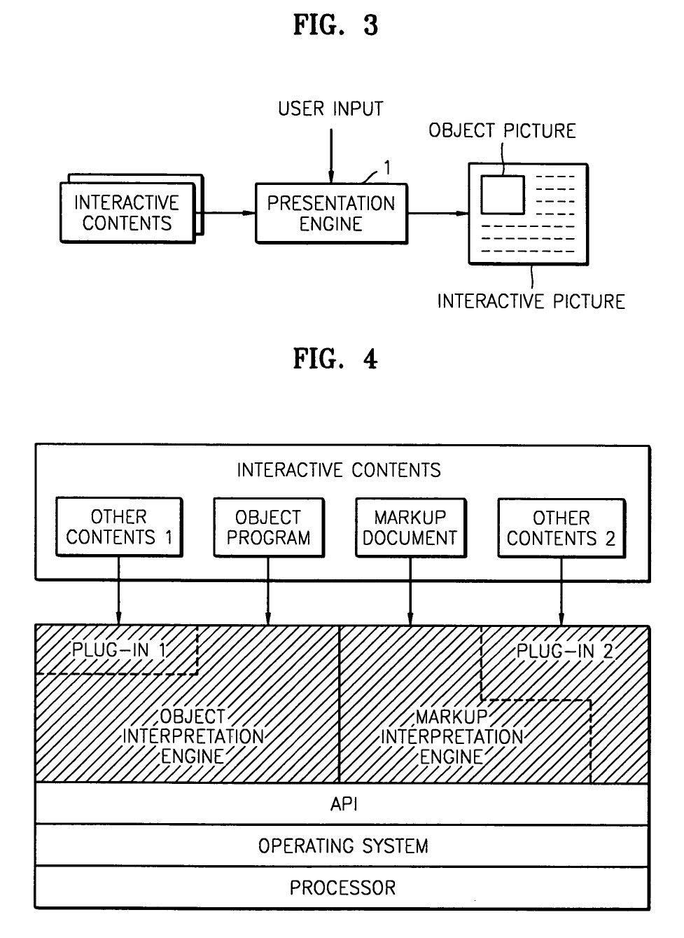

FIG. 3 is a functional block diagram of an apparatus displaying/playing back interactive contents, according to an embodiment of the present invention. Referring to FIG. 3, the apparatus is realized by a presentation engine 1, which is software controlling the apparatus displaying interactive contents (i.e., controlling an interactive contents playback system, such as the home DVD playback system including a DVD player and a TV/display monitor). In the present invention, interactive contents are data for displaying an interactive picture in which an object picture is embedded. According to an embodiment of the present invention, the interactive contents is a markup document and an object program, which when displayed/played back are referred to as a markup picture including an embedded object picture. In other words, a markup document is data for an interactive (markup) picture and the object program is data for an object picture displayed while being embedded in the interactive (markup) picture.

In FIG. 3, the presentation engine 1 receives, interprets, and presents the interactive contents. The presentation engine 1 also interprets the object program to generate input item map information necessary for focusing on input items in the object picture and focuses on one of the input items in the object picture with reference to the object picture input item map information in response to a key input from a user input device, such as a keyboard, a remote control, or the like, other than a pointing device. In the present invention, an input device of an interactive contents playback system can be any non-pointer type input device, such as a remote control device, a keyboard, input buttons/keys, or etc (i.e., a pointer-less input device) and a pointer type input device, such as a mouse. The claimed invention is directed to allowing using non-pointer type data input devices to focus on object picture input items embedded in a markup picture according to a markup document. An interactive contents playback system of the invention can also conventionally accept a pointing device input to focus on such object picture input items.

FIG. 4 is a functional layer diagram of the interactive contents playback apparatus shown in FIG. 3, according to an alternative embodiment of the present invention. As shown in FIG. 4, alternatively, the presentation engine 1 may include a markup interpretation engine and an object interpretation engine, to focus on one of the object picture and markup picture input items according to a predetermined order through the exchange of a message between the markup interpretation engine and the object interpretation engine in response to a pressed key of the user input device to move a focus. For example, a focus can be moved from a markup picture input item to an object picture input item and vice versa by exchanging focus change messages between the markup interpretation engine and the object interpretation engine.

Referring to FIG. 4, the interactive contents include a markup document and an object program and may optionally further include other contents 1 and 2. The markup document is written in a markup language, such as the extensible markup language (XML), the hypertext markup language (HTML), or the like, using a corresponding markup document generator application program. The object program is linked to the markup document to display an animation flash or a moving picture (i.e., an object picture) embedded in a markup picture generated according to the markup document. In particular, the object program includes information for generating input item map information necessary for focusing on input items in the object picture (i.e., an object picture input item map). According to an aspect of the invention, the object program is coded in Java language, the other contents 1 are sound data, and the other contents 2 are image data.

The presentation engine 1 is realized by a processor with an operating system (OS). More particularly, the processes of the present invention as embodied in the presentation engine 1 are implemented in software and the interactive contents play back system comprises a processor programmed by the presentation engine 1 to control the system according to the processes of the present invention. As regards software, the presentation engine 1 comprises an object interpretation engine and a markup interpretation engine as applications communicating with the OS via an application program interface (API). The object interpretation engine is an application interpreting and executing the object program, and the markup interpretation engine is an application interpreting and executing the markup document. Typically, a plug-in 1, which is an application plugged in the object interpretation engine, and a plug-in 2, which is an application plugged in the markup interpretation engine and communicating with the OS via the API, are installed in the presentation engine 1. The plug-in 1 is a decoder decoding the other contents 1 and the plug-in 2 is a decoder decoding the other contents 2. The plug-ins 1 and 2 may be optionally installed.

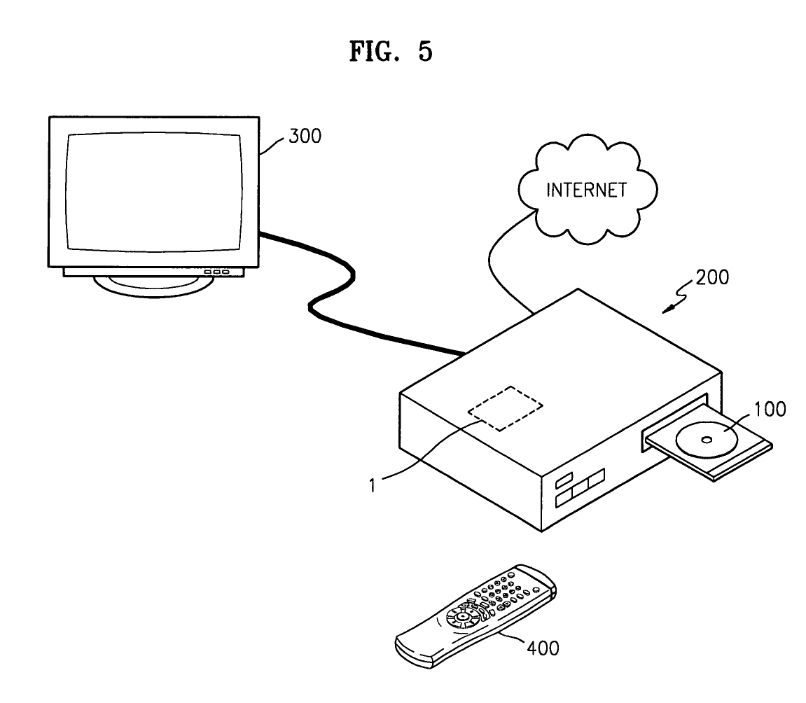

FIG. 5 is a diagram of an interactive contents playback system including a playback device 200 embodying the presentation engine 1 shown in FIGS. 3 and 4, and including a display monitor 300, according to an embodiment of the present invention. Referring to FIG. 5, the playback system includes a disc 100 as an information storage medium, the playback device 200, a TV 300 as a display device, and a remote control 400 as a user input device. The remote control 400 receives a control command from a user and transmits the control command to the playback device 200. The playback device 200 includes a drive (not shown) for reading interactive data recorded on the disc 100. When the disc 100 is loaded into the drive, the playback device 200 plays back interactive contents recorded on the disc 100 and transmits the played back interactive contents to the TV 300 for displaying. A picture formed by playing back the interactive contents is displayed on the TV 300. In other words, if the disc 100 stores a markup document as the interactive contents, a markup picture in which an embedded object picture formed by an object program is displayed. Moreover, according to an aspect of the invention, the playback device 200 can be connected to a network, such as the Internet to transmit interactive contents data to and receive interactive contents data from the network. More particularly, the present invention's object picture input item focus control method can be applied to interactive contents playback apparatuses receiving and playing back the interactive contents embodied in carrier waves.

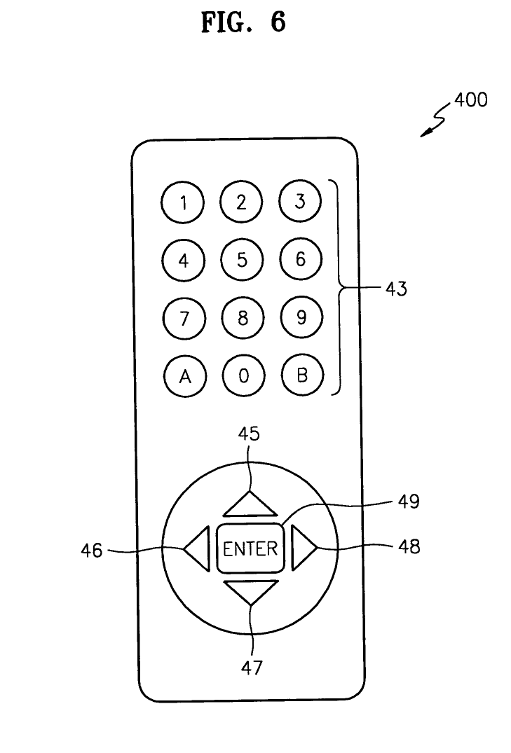

FIG. 6 is a diagram of the remote control 400 shown in FIG. 5. Referring to FIG. 6, typically, number and specific character buttons 43 are arranged in a front upper portion of the remote control 400. Typically, a direction key 45 for moving a focus on an input item displayed on a screen (not shown) of the TV 300 upward, a direction key 47 for moving the focus downward, a direction key 46 for moving the focus to the left, and a direction key 48 for moving the focus to the right, are arranged in a front lower portion of the remote control 400. Typically, an “ENTER” key 49, which is used for selecting a focused displayed input item (i.e., a selected displayed input item) by the remote control 400, is positioned in the middle of the direction keys 45, 46, 47, and 48. According to the present invention, a user can move the focus among displayed input items in a markup picture, among input items in an object picture embedded in the mark up picture, from the input items in the markup picture to the input items in the embedded object picture of the markup picture, and from the input items in the embedded object picture of the markup picture to the input items in the markup picture using the direction keys 45, 46, 47, and 48. In other words, the user can move the focus among the input items without distinguishing the input items in the markup document from the input items in the object picture, using the remote control 400.

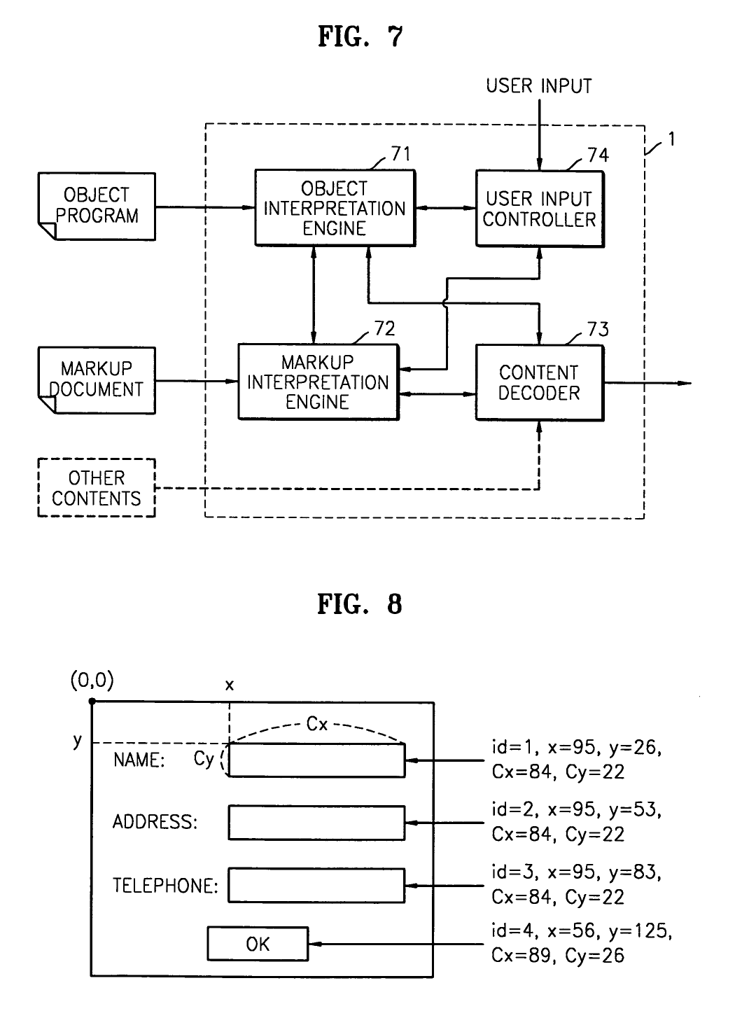

FIG. 7 is a functional block diagram of the presentation engine 1 shown in FIG. 4, according to an embodiment of the present invention. Referring to FIG. 7, the presentation engine 1 comprises an object interpretation engine 71, a markup interpretation engine 72, a content decoder 73, and a user input controller 74. The object interpretation engine 71 interprets an object program, generates object picture input item map information necessary for focusing on the object picture input items, and transmits the object picture input item map information to the user input controller 74. The markup interpretation engine 72 interprets a markup document, if the markup document contains focusable elements (input items), generates input item map information necessary for focusing on the markup input items according to the present invention, and transmits the markup input item map information to the user input controller 74. The user input device 74 stores the object picture input item map information, typically generated by the object interpretation engine and transmitted from the object interpretation engine 71 and/or the markup picture input item map information, typically generated by the markup interpretation engine 72 and transmitted by the markup interpretation engine 72. The user input controller 74 moves a focus on an input item (i.e., either an object picture or a markup picture input item) to a corresponding input item (i.e., either an object picture or a markup picture input item) based on the stored object picture and/or markup picture input item map information, in response to a key of the remote control 400 pressed to move the focus as a user input. More particularly, the user input controller 74 can process a focus movement instruction for both the object picture and the markup picture from any user input device without distinguishing between pointer type and non-pointer type input devices.

Alternatively, the object interpretation engine 71 and the markup interpretation engine 72 may transmit and receive a message for moving the input item focus in response to the key of the remote control 400 pressed to move the focus. Thus, the object interpretation engine 71 or the markup interpretation engine 72, which has received the message for moving the focus, focuses on one of object picture or markup picture input items, respectively, according to an order predetermined in the message.

The content decoder 73 decodes moving picture data, image data, and/or audio data received from the object interpretation engine 71 and other contents displayed while linking to the markup document (i.e., object picture embedded in the markup picture), and then outputs the decoded data and the other contents.

FIG. 8 is a reference view of a display screen displaying an example object picture having input items and an example map of the object picture input items for focusing on the object picture input items, according to an embodiment of the present invention. Referring to FIG. 8, for example, input forms of three input items, i.e., name, address, and telephone number forms, and one “OK” button are made in an object picture. A focus can move among the input forms and the “OK” button. In particular, the input items for inputting a name, an address, and a telephone number are formed by the input forms, and an input item for submitting data input in the input forms is formed by the “OK” button as a button input type.

The object interpretation engine 71 generates and/or contains the object picture input item map for the object picture shown in FIG. 8 as follows. An identification (id), for example, “1”, is assigned to the input form into which the name is input. As information on the position of the name input form, coordinates (x, y) of a left upper apex of the name input form are set to (95, 26), when the left upper apex of the object picture is coordinates (0,0). Also, as information on lengthwise and widthwise lengths of the name input form measured from the left upper apex of the name input form, (cx, cy)=(84, 22) are assigned to the name input form. An id, for example, “2”, is assigned to the input form of the address. As information on the position of the address input form, coordinates (x, y) of a left upper apex of the address input form are set to (53, 84). Also, as information on lengthwise and widthwise lengths, (cx, cy)=(84, 22) are assigned to the address input form. An id, for example, “3”, is assigned to the input form of the telephone number. As information on the position of the telephone number input form, coordinates (x, y) of a left upper apex of the telephone number input form are set to (83, 84). Also, as information on lengthwise and widthwise lengths of the telephone number input form, (cx, cy)=(84, 22) are assigned to the telephone number input form. An id, for example, “4”, is assigned to the “OK” button. As information on the position of the “OK” button, coordinates (x, y) of a left upper apex of the “OK” button are set to (56, 125), and as information on lengthwise and widthwise lengths of the “OK” button input form, is (cx, cy)=(89, 26) are assigned to the “OK” button input form.

The above described object picture input item map information can be expressed in an XML document as shown below.

```
inputmap<inputitemlist>
  <inputitem type=“textfield” x=“95” y=“26” cx=“84” cy=“22” id=“1” />
  (1) Interpret this part.
  <inputitem type=“texffield” x=“95” y=“53” cx=“84” cy=“22”
  id=“2” />
  <inputitem type=“textfield” x=“95” y=“83” cx=“84” cy=“22” id=“3” />
  <inputitem type=“button” x=“56” y=“125” cx=“89” cy=“26” id=“4” />
  </itemlist>
  <focusinputlist>
  <focusitem id=“1” down=“2”>
  <focusitem id=“2” up=“1” down=“3”> (2) Interpret this part.
  <focusitem id=“3” up=“2” down=“4”>
  <focusitem id=“4” up=“3” >
  </focusinputlist>
  </inputmap>
```

The above XML document includes of the <itemlist> and the <focusitemlist> parts (elements). The <itemlist> element describes which input item is focused by a focus, and the <focusitemlist> element describes to which input item the focus moves according to the direction keys 45, 46, 47 and 48 of the remote control 400. As examples, interpretations of a portion of the <itemlist> part and a portion of the <focusitemlist>, with reference to interpretations (1) and (2) in the above XML definition, are as follows.

Interpretation (1): An input item of a text field form (i.e., in FIG. 8, the name input form), which has 1 as an identification value, and width and height of 84 and 22, respectively, can receive a key input. An input form type of the input item may be selected from various input forms, such as a “TextArea”, “Button”, “TextField”, “List”, “CheckBox”, or the like.

Interpretation (2): If a focus movement is performed from a currently focused input item having an identification of “2”, when an upper direction key 45 is pressed, the current focus moves from the input item having the id of “2” to an input item having an id of “1” (i.e., in FIG. 8, the current focus moves from the address input form to the name input form). However, if a lower direction key 47 is pressed, the current focus moves to an input item having an id of “3” (i.e., in FIG. 8, the current focus moves from the address input form to the telephone number input form).

Typically, the object picture input item map information defined according to the XML and necessary for focusing on the object picture input items is contained in the object program, which is a Java program, interpreted by the object interpretation engine 71. Thus, when the Java program is executed in the object interpretation engine 71, and the object picture input item map is transmitted to the user input controller 74, the user can perform a focus control for the object picture input items via a key input from the remote control 400.

As an example, the above described XML document defining the object picture input item map and as contained (i.e., as retrieved via a Java function call) in a Java program source code is as follows.

```
import java.applet.*;
public class AnimationApplet extends Applet implements Runnable {
  BUTTON currentOwner;
  Thread animator;
public void init( )
{// called if an applet is loaded
  animator = new Thread(this);
  // generate input items for receiving input data.
  new textField(95,39,84,22,1);
  new textField(95,53,84,22,2);
  ...
}
public void start( )
{// called if visiting a page containing an applet
  if (animator.isAive( )) {
  animator.resume( );
  }
else {
  animator.start( );
  }
}
public void stop( )
{// called if leaving the page containing the applet
  animator.suspend( );
}
public void destroy( )
{// called if a markup interpretation engine stops
  animator.stop( );
}
public void run( )
{// executed whenever a thread is executed
  String focus_map;
  while(true) {
    repaint( );
    Thread.sleep(100); // sleep for some time
    check whether focus input is changed?
    if it is changed then
    {
      focus_map = get_new_focusmap( ); // get a new input map.
      sendFocuslnputMap(focus_map); // send an input map to an UI
      controller
    }
    }
  }
public void paint(Graphics g)
{/* a function for drawing a shape of an output picture of an Applet */
...draw a focus indication information...
...draws other information.
}
String get_new_focusmap( )
{// returns a new input map.
  // one input map is simply used here, but if necessary
  // the input map may vary.
  String returnmap;
  returnmap = “<inputmap>”
    +“<inputitemlist>”
    +“<inputitem type=\“textfield\” x=\“95\”
    y=\“26\” cx=\“84\” cy=\“22\” id=\“1\” />”
    +“<inputitem type=\“textfield\” x=\“95\”
    y=\“53\” cx=\“84\” cy=\“22\” id=\“2\” />”
    +“<inputitem type=\“textfield\” x=\“95\”
    y=\“83\” cx=\“84\” cy=\“22\” id=\“3\” />”
    +“<inputitem type=\“textfield\” x=\“56\”
    y=\“125\” cx=\“89\” cy=\“26\” id=\“4\” />”
    +“</itemlist>”
    +“<focusinputlist>”
    +“<focusitem id=\“1\” down=“2”>”
    +“<focusitem id=\“2\” up=“1” down=“3”>”
    +“<focusitem id=\“3\” up=“2” down=“4”>”
    +“<focusitem id=\“4\” up=“3”>”
    +“</focusinputlist>”
    +“</inputmap>”;
  return returnmap;
  }
}
```

The above Java program source code may be made into other formats according to an XML document type definition (DTD). Alternatively, the above XML document defining the object picture input item map may be defined according to the Java programming language. An example source code of such Java program is described below.

TInputMap im= new InputMap( );
TInputItem it = new TInputItem(TInputItem.TextField,
95,26,84,22,−1,2,−1,−1,1); im.add(it);
TInputItem it = new TInputItem(TInputItem.TextField,
95,53,84,22,1,3,−1,−1,2); im.add(it);
TInputItem it = new TInputItem(TInputItem.TextFieid,
95,83,84,22,2,4,−1,−1,3); im.add(it);
TInputItem it = new TInputItem(TInputItem.Button,
95,125,89,26,3,−1,−1,−1,4); im.add(it)

Furthermore, an example of a Java program source code using an API for the object picture input item map information is as follows.

```
import java.applet.*;
public class AnimationApplet extends Applet implements Runnable {
  BUTTON currentOwner;
  Thread animator;
public void init( )
{// called if an applet is loaded
  animator = new Thread(this);
  // generate input items for receiving input data.
  new textField(95,26,84,22,1);
  new textField(95,53,84,22,2);
  ...
}
public void start( )
{// called if visiting a page containing an applet
  if (animator.isAive( )) {
    animator.resume( );
  }
  else {
    animator.start( );
  }
}
public void stop( )
{// called if leaving the page containing the applet
  animator.suspend( );
}
public void destroy( )
{// called if a markup interpretation engine stops
  animator.stop( );
}
public void run( )
{// executed whenever a thread is executed
    String focus_map;
  while(true) {
    repaint( )
    Thread.sleep(100); // sleep for some time
  check whether focus input is changed?
  if it is changed then
  {
  // if input item map information is written using an API
  // a simple example is taken here, but if necessary
  // the input item map information may vary.
  TInputMap im = new InputMap( );
  TInputItem it = new TInputItem(TInputItem.TextField,
  95,26,84,22,−1,2,−1,−1,1); im.add(it);
  TInputItem it = new TInputItem(TInputItem.TextField,
  95,53,84,22,1,3,−1,−1,2); im.add(it);
  TInputItem it = new TInputItem(TInputItem.TextField,
  95,83,84,22,2,4,−1,−1,3); im.add(it);
  TInputItem it = new TInputItem(TInputItem.Button,
  95,125,89,26,3,−1,−1,−1,4); im.add(it);
  sendFocusInputMap(im); // transmit an input map to an UI controller
  }
  }
}
public void paint(Graphics g)
{/* a function for drawing an output shape of an object picture */
  ...draw a focus indication information...
  ...draws other inoformation.
}
```

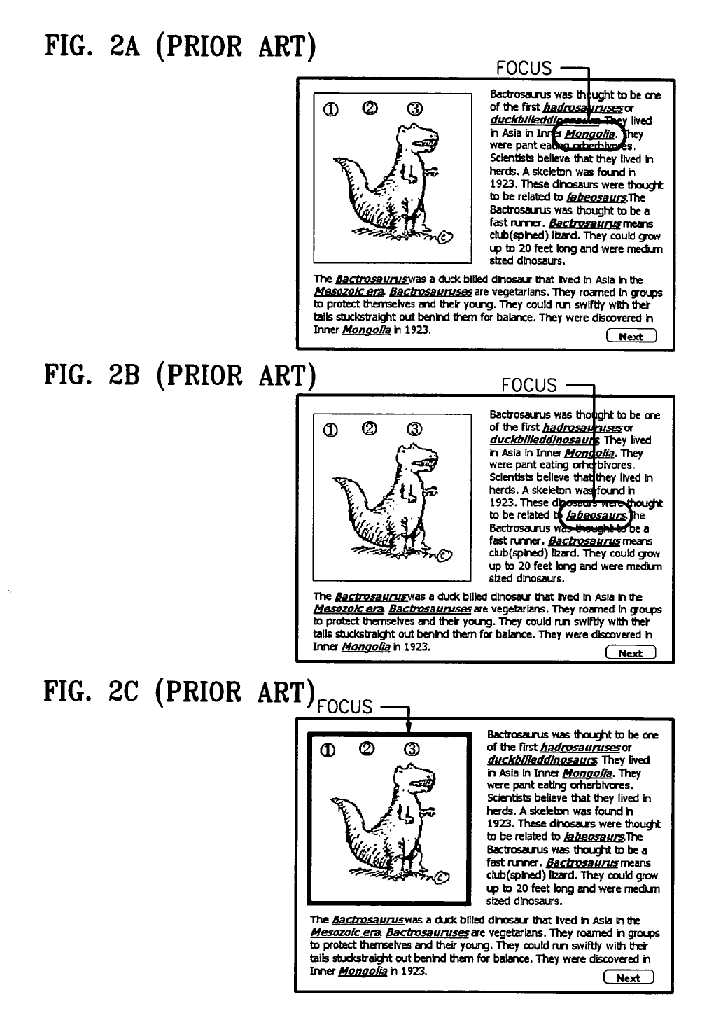

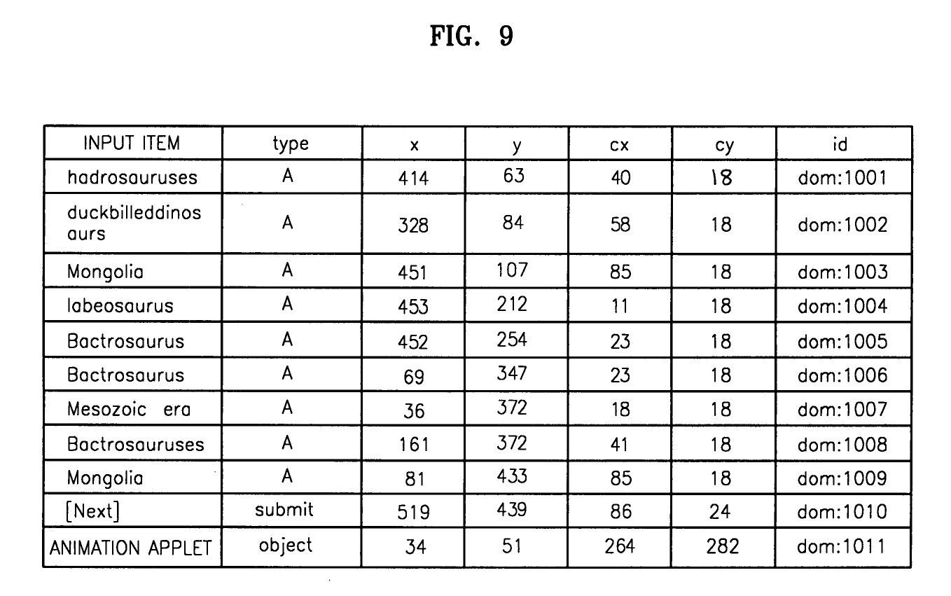

FIG. 9 is a markup picture input item map information table necessary for focusing on the input items in the markup picture shown in FIG. 2, according to an embodiment of the present invention. Referring to FIG. 9, the markup picture input item map information contains information on input item types, positions, and identifications of the input items. In FIG. 2, with respect to, for example, a dinosaur in a markup picture as displayed interactive contents, a dinosaur name is an input item, e.g., in FIG. 9, the input item type of “hadrosauruses” is Anchor (A) and the “id” thereof is “dom: 1001”. Also, as information on the position of the “hadrosauruses” input item, the (x, y) coordinates of a top left corner of the input item are (414, 63), with respect to a top left corner of the markup picture, and the lengthwise and widthwise lengths of the input item form are (cx, cy)=(40, 18). The input type of a “[Next]” button as an input item is “submit” and the “id” thereof is “dom: 1010”. Also, as information on the position of the “[Next]” button, the (x, y) coordinates of a top left corner of the “[Next]” button are (519, 439), and the lengthwise and widthwise lengths of the “[Next]” button are (cx, cy)=(86, 24). The object picture embedded in the markup picture, in which the dinosaur is displayed, is an animation applet, which is also an input item in the markup picture. The input type of the object picture is “object” and the id thereof is “dom: 1011”. Information on the position of the object picture is composed of the (x, y) coordinates of a top left corner of the object picture (x, y)=(34, 51) and lengthwise and widthwise lengths of the object picture (cx, cy)=(264, 282).

In FIG. 2, the object picture input item map information necessary for focusing on input items of the object picture showing the dinosaur animation can be generated using the same method as the input item map information described with reference to FIG. 7. Thus, descriptions thereof will be omitted.

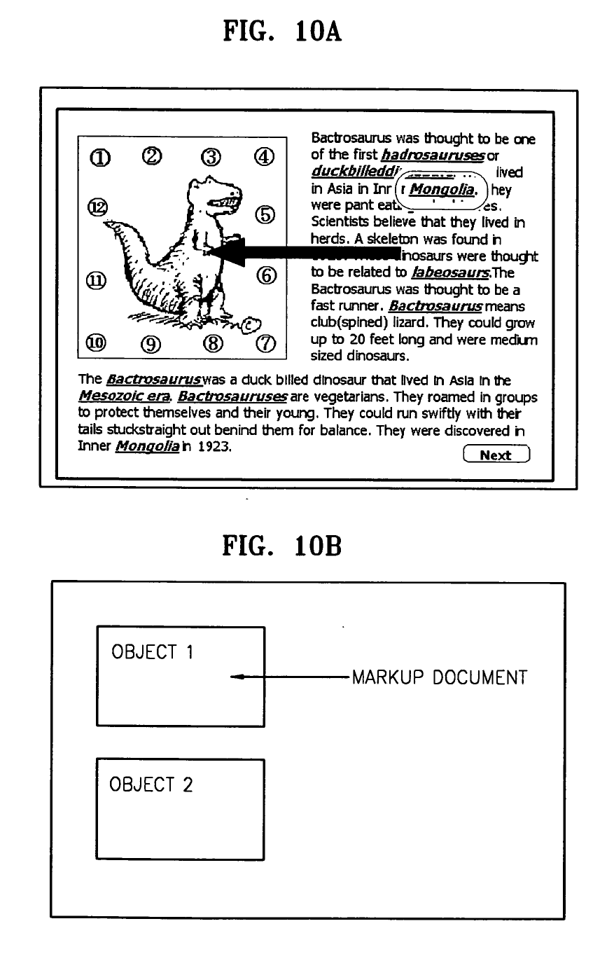

FIGS. 10A and 10B are reference views of display screens displaying a markup picture including an embedded object picture for explaining a method of focusing on the object picture input items, according to the alternative embodiment of the present invention. FIG. 10A illustrates a markup picture in which an object picture showing a dinosaur animation is embedded. According to the present embodiment, a focus moves from input items in the object picture to input items in the markup picture by exchanging a message between the object interpretation engine 71 and the markup interpretation engine 72. In other words, the object interpretation engine 71 and the markup interpretation engine 72 transmit and receive a control command for moving the focus through the message exchange. When the focus is desired to be moved toward the object picture as indicated by the thick arrow in FIG. 10A, i.e., from the input items in the markup picture to the input items in the object picture, as shown in FIG. 10B, the markup interpretation engine 72 transmits a message containing information for moving the focus to the object interpretation engine 71 in response to a key of the remote control 400 pressed to move the focus (e.g., in response to one of the direction keys 45, 46, 47 and 48 in a direction of the object picture leaving the markup picture as the case may be, or any other designated key to move the focus from a markup picture input item to an object picture input item). Then, the object interpretation engine 71 focuses on one of the input items of the object picture according to a predetermined order in response to the message received from the markup interpretation engine 72 and according to the object picture input item map for the object picture as contained in/retrieved by a corresponding object picture program.

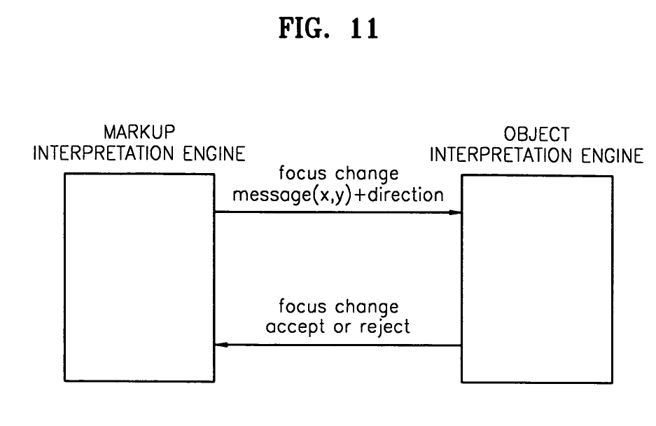

FIG. 11 is a flow diagram of the method presented in FIG. 10. Referring to FIG. 11, the markup interpretation engine 72 informs the object interpretation engine 71 of information on a currently focused position (x, y) and information on a direction of a position toward which the focus is to be moved from the currently focused position as a focus change message. For example, a focus change message format can be: “focus change message (x, y)+direction.” The object interpretation engine 71 informs the markup interpretation engine 72 of an acceptance or rejection of the message. If the object interpretation engine 71 accepts the message, the object interpretation engine 71 moves the focus from a currently focused input item to a next input item selected based on the direction information contained in the message. For example, if a user presses the direction key 45 for moving the focus up, the object interpretation engine 71 moves the focus from the currently focused markup picture input item to one of the object picture input items nearest to the currently focused markup picture input item in the upper portion of the object picture. Typically, the object picture can be properly divided into upper and left or right portions for such focus movement between the markup picture input items and the object picture input items.

An example source code of a focus change program for moving a focus between the markup picture input items and the object picture input items is as follows.

```
import java.applet.*;
public class DemandFocusApplet extends Applet {
  BUTTON currentOwner;
public void paint(Graphics g)
{/* a function for drawing a shape of an output picture of an Applet */
...draw a focus indication information...
  ...draws other information.
}
public boolean demandFocusOwner(int x, int y, int dir)
{/* a function called when being a focus owner is confirmed by a
document */
  check whether applet can get focus from parent document on direction
  ‘dir’ at
    position(x,y).
if applet can get the focus, then return (true);
  else return (false);
}
public boolean gotFocus(int x, int y,int dir)
{/* a function called when an applet gets a focus from a document*/
  set the button to be focused on dirction ‘dir’ at position(x,y).
}
public boolean keyDown(Event e, int key)
{/* a function called when a remote control is pressed*/
  if applet can lose a focus because the user pressed a direction key to
    go out of the focused applet, then call focus_change(key)
  else
    user navigates within the object boundary of the applet.
}
void focus_change(dir)
{/* a function for changing a focus according to a pressed direction key */
  // current focus owner is stored in currentOwner
  BUTTON nextOwner;
  int x, y;
  x = getFocusawnerPosition(1); // current focus position X
  y = getFocusOwnerPosition(2); // current focus position Y
  nextOwner = find NextFocusOwner(currentOwner,x,y,dir);
  if (nextOwner == currentOwner)
  {
  if (notifyFocus(document,x,y,direction) == focus accept))
  {
    loseFocus(currentOwner);
    setFocus(document);
    }
  return;
  }
  loseFocus(currentOwner);
  setFocus(nextOwner);
  currentOwner = nextOwner;
  }
}
```

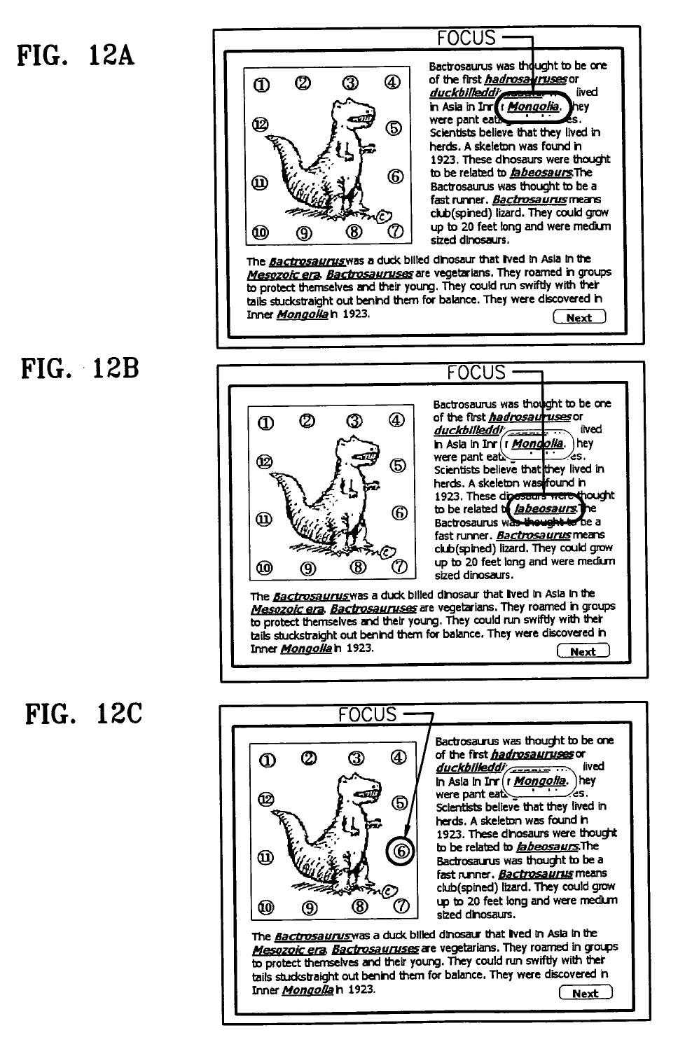

FIGS. 12A, 12B, and 12C are reference views of display screens displaying a markup picture including an embedded object picture for explaining moving a focus among input items in the markup picture and the embedded object picture, according to an embodiment of the present invention. Referring to FIG. 12A, a focus is initially on a markup picture input item “Mongolia.” When a user presses the direction key 47 of the remote control 400 for moving the focus down, as shown in FIG. 12B, the focus moves down to a markup picture input item “labeosaurs” nearest to the markup picture input item “Mongolia.” When the user presses the direction key 46 for moving the focus to the left, as shown in FIG. 12C, the focus moves to an object picture input item \mathring{6} nearest to the left of the markup picture input item “labeosaurs.” Unlike the prior art in which a focus is placed only on the entire object picture, in the present invention, the focus is moves from the input items in the markup picture to the input items in the object picture without distinguishing the input items of the object picture from the input items of the markup picture.

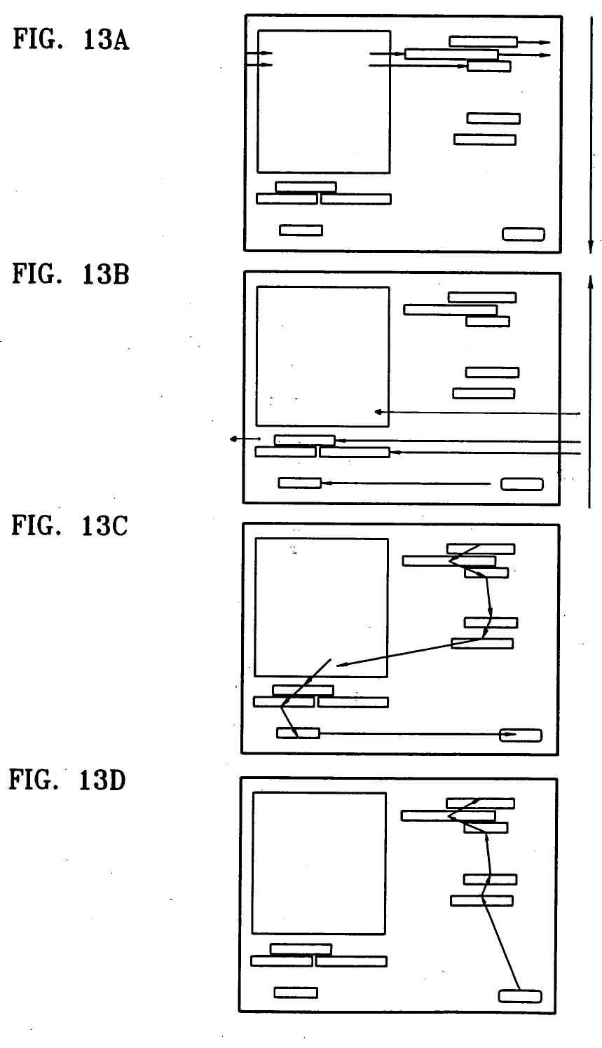

FIGS. 13A, 13B, 13C and 13D are reference views of the display screens in FIGS. 12A, 12B and 12C for explaining a moving order of the focus among the input items in the markup picture in which the object picture is embedded, according to an embodiment of the present invention. Referring to FIG. 13A, when a currently focused input item is positioned at an upper side of the markup picture and a user presses the right direction key 49 or the lower direction key 47, the presentation engine 1 (or the user input controller 74 in response to the markup interpretation engine 72 and the object interpretation engine 71) moves the focus through the markup picture input items and the object picture items, as the case may be, while searching for a next input item from right to left and then downward. A returning path of the focus may be determined separately from the starting moving direction of the focus.

Referring to FIG. 13B, when a currently focused input item is positioned at a lower right side of the markup picture and a user presses the left direction key 46 or the upper direction key 45, the presentation engine 1 (or the user input controller 74 in response to the markup interpretation engine 72 and the object interpretation engine 71) moves the focus through the markup picture input items and the object picture items, as the case may be, while searching for a next input item from left to right and then upward. Again, a returning direction of the focus may be determined separately from the starting moving direction of the focus.

Referring to FIG. 13C, when a currently focused input item is positioned at an upper right side of the markup picture and a user presses the left direction key 46 or the lower direction key 47, the presentation engine 1 (or the user input controller 74 in response to the markup interpretation engine 72 and the object interpretation engine 71) moves the focus through the markup picture input items and the object picture items, as the case may be, while searching for a next input item downward with reference to a distance and a direction angle of each input item. Here, the presentation engine 1 (or the user input controller 74) stores information on previously focused input items, and when the user presses the upper direction key 45, the presentation engine 1 moves the focus according to the order of the previously focused input items.

Referring to FIG. 13D, when a currently focused input item is positioned at a lower right side of the markup picture and a user presses the upper direction key 45, the presentation engine 1 (or the user input controller 74 in response to the markup interpretation engine 72 and the object interpretation engine 71) moves the focus upward through the markup picture input items and the object picture items, as the case may be, while searching for a next input item with reference to the distance and direction angles of each input item. Here, the presentation engine 1 (or the user input controller 74) stores information on previously focused input items, and when the user presses the lower direction key 47, the presentation engine 1 moves the focus according to the order of the previously focused input items.

As described above, according to the present invention, a focus can freely move among input items in an embedded object picture of a markup picture and the input items in the markup picture using any input device without distinguishing between the input devices (i.e., the presentation engine 1 can focus on object picture input items according to non-pointing devices, such as a mouse, a trackball, etc.). The processes of the present invention as embodied in the presentation engine 1, including the functional blocks thereof as shown in FIG. 7, are implemented in software controlling an interactive contents playback/reproducing device to display interactive contents, including embedded pictures/images, and to manage focus movements among the displayed interactive contents, including the embedded picture/images, in response to non-pointer type user input devices. The present invention provides a markup picture display system, comprising a display, a non-pointer type input device, and a programmed computer processor processing a markup document to generate on the display a markup picture having at least one input item and the markup picture including an embedded object picture having at least one input item; and focusing on the markup picture input items and the object picture input items according to a predetermined order, in response to an input by the non-pointer type input device. The markup picture display system further comprises a digital video disc (DVD) storing the markup document and a DVD video as the object picture embedded in the markup picture, wherein the display is a television, the programmed computer processor is a DVD player processing the markup document stored on the DVD disc, and the non-pointer type input device is a remote control of the DVD player.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of focusing on at least one of input items in an object picture embedded in a markup picture, the method comprising:
interpreting an object program for the object picture to generate input item map information necessary for focusing on the input items; and
focusing on one of the input items with reference to the input item map information in response to a key input from a user input device.

2. The method of claim 1, wherein the object program has an independent program structure according to an extensible markup language (XML) document and a Java program.

3. The method of claim 1, wherein the object program interpreting comprises:
obtaining information on input types of the input items, information on positions of the input items, and information on identifications of the input items from the object program; and
generating the input item map information based on the information on the input item types, the input item position information, and the input item identification information.

4. The method of claim 3, wherein the focusing comprises moving a focus from a currently focused input item to an input item nearest to a direction indicated by a direction key of the user input device based on the input item type information, the input item position information, and the input item identification information.

5. A method of focusing on at least one of input items in an object picture embedded in a markup picture, the method comprising:
transmitting a message from a markup interpretation engine for the markup picture to an object interpretation engine for the object picture for moving an input item focus, in response to a pressed key of a user input device to move the focus; and
focusing by the object interpretation engine on one of the object picture input items according to a predetermined order in response to the message.

6. A method of focusing on at least one of input items in an object picture embedded in a markup picture, the method comprising:
transmitting a message from an object interpretation engine for the object picture to a markup interpretation engine for the markup picture for moving an input item focus, in response to a pressed key of a user input device to move the focus; and
focusing by the markup interpretation engine on one of the markup picture input items according to a predetermined order in response to the message.

7. The method of claim 5, wherein the message transmission comprises transmitting information on a position of a currently focused markup picture input item and information on a direction along which the focus moves.

8. The method of claim 7, wherein the focusing comprises:
moving the focus from the currently focused markup picture input item to a next object picture input item positioned in an object picture direction selected based on the direction information.

9. The method of claim 5, wherein the focusing comprises:
moving the focus from the currently focused markup picture input item to a next object picture input item determined with reference to a distance and a direction angle of each markup picture and object picture input item.

10. An information storage medium storing information controlling an interactive contents playback apparatus, the storage medium comprising:
a markup document written in markup language; and
an object program to display an object picture having at least one input item and embedded in a markup picture formed by the markup document, the object program containing information on an input item type, information on a position of an input item, and information on an identification of an input item necessary for generating input item map information.

11. The information storage medium of claim 10, further comprising at least one of audio contents reproduced and image contents displayed by the object program while being embedded in the markup picture.

12. The information storage medium of claim 10, wherein the object program has an independent program structure according to an extensible markup language (XML) document and a Java program.

13. An information storage medium storing information controlling an interactive contents playback apparatus, the storage medium comprising:
a markup document written in markup language;
an object program to display an object picture having at least one or more input items and embedded in a markup picture having at least one or more input items and formed by the markup document; and
a focus change program controlling transmitting a message for moving a focus on one of the object picture input items from an object interpretation engine for the object picture to a markup interpretation engine for the markup picture, in response to a pressed key of a user input device to move the object picture focus, and focusing on one of the markup picture input items according to a predetermined order in response to the message using the markup interpretation engine.

14. The information storage medium of claim 13, wherein the message comprises information on a position of a currently focused object picture input item and information on a direction along which the focus moves.

15. The information storage medium of claim 13, wherein the focus change program controls moving the focus from a currently focused object picture input item to a next markup picture input item positioned in a markup picture direction selected based on the message transmitted from the object interpretation engine.

16. The information storage medium of claim 13, wherein the focus change program controls moving the focus from a currently focused object picture input item to a next focused markup picture input item determined with reference to a distance and a direction angle of each object picture and markup picture input item.

17. An markup picture display system, comprising:
a display;
a non-pointer type input device; and
a programmed computer processor processing a markup document to generate on the display a markup picture having at least one input item and the markup picture including an embedded object picture having at least one input item; and moving an input item focus among the markup picture input items and the object picture input items according to a predetermined order, in response to an input by the non-pointer type input device.

18. The system of claim 17, further comprising a digital video disc (DVD) storing the markup document and a DVD video as the object picture embedded in the markup picture, wherein:
the display is a television;
the programmed computer processor is a DVD player processing the markup document stored on the DVD disc; and
the non-pointer type input device is a remote control of the DVD player.

19. The system of claim 17, wherein as the programmed processor an object interpretation engine, which processes the markup document, and a markup interpretation engine, which processes an object program to display the object picture embedded in the markup picture, exchange messages to control the input item focus movement among the object picture and markup picture input items, in response to a key input of the non-pointer type input device.

20. The system of claim 19, wherein the message comprises information on a position of a currently focused object picture or markup picture input item and direction information along which the focus moves.

21. An interactive DVD content player, comprising:
a non-pointer type input device; and
a programmed computer processor processing a markup document to generate a markup picture having at least one input item and the markup picture including an embedded DVD object picture having at least one input item; and moving an input item focus among the markup picture input items and the DVD object picture input items according to a predetermined order, in response to an input by the non-pointer type input device.

22. An interactive contents playback apparatus, comprising:
a non-pointer type input device;
a reader reading interactive contents including an object program; and
a presentation engine processing the interactive contents, including the object program, to generate an interactive picture having at least one input item, the interactive picture including an embedded object picture based upon the object program and having at least one input item; and moving an input item focus among the interactive picture input items and the object picture input items according to a predetermined order, in response to a user input by the non-pointer type input device.

23. The apparatus of claim 22, wherein the interactive contents is a markup document, and the presentation engine comprises:
a markup interpretation engine interpreting the markup document to generate a markup picture as the interactive picture and to generate a markup picture input item map for focusing on the markup picture input items;
an object interpretation engine interpreting the object program to embed the object picture in the interactive picture and to generate an object picture input item map for focusing on the objection picture input items; and
a user input controller storing the markup picture and the object picture input item maps and moving the input item focus among the markup picture input items and the object picture input items according to the markup picture and the object picture input item maps.

24. The apparatus of claim 22, wherein the non-pointer type input device is a remote control comprising four direction keys moving the input item focus in up, right, down, and left directions, and the presentation manager moves the input item focus from an interactive picture input item to an object picture input item in response to one of the direction keys in a direction of the object picture leaving the interactive picture.

25. The apparatus of claim 22, wherein the non-pointer type input device is a remote control comprising four direction keys moving the input item focus in up, right, down, and left directions, and the presentation manager moves the input item focus upward or downward through the interactive picture input items and the object picture input items in response to the up or the down key, respectively, by searching for a next input item with reference to a distance and direction angles of each input item.
